(19) United States
(12) Patent Application Publication
(10) Pub. No.: US 2023/0308937 A1
(43) Pub. Date: Sep. 28, 2023

(54) MULTI-DOMAIN NETWORK DATA FLOW MODELING

(71) Applicant: QUALCOMM Incorporated, San Diego, CA (US)

(72) Inventors: Jordi ROS GIRALT, Vilafranca del Penedes (ES); Noah Isaac AMSEL, New York, NY (US); Lucia Regina O’TOOLE, Somerville, MA (US); Sruthi YELLAMRAJU, Germantown, MD (US)

(21) Appl. No.: 18/049,159

(22) Filed: Oct. 24, 2022

Related U.S. Application Data
(60) Provisional application No. 63/301,901, filed on Jan. 21, 2022.

(51) Int. Cl. H04W 28/02; H04W 24/10

(52) U.S. Cl. CPC H04W 28/0273; H04W 24/10

(57) ABSTRACT

Various aspects of the present disclosure generally relate to wireless communication. In some aspects, a network entity may generate a data flow model for a domain associated with the network entity, the domain being part of a multi-domain network. The network entity may obtain a set of measured flow rates and a set of expected flow rates that are calculated based at least in part on the data flow model. The network entity may selectively update the data flow model based at least in part on an accuracy of the data flow model, with the accuracy determined based at least in part on the set of measured flow rates and the set of expected flow rates. Numerous other aspects are described.

### CROSS-REFERENCE TO RELATED APPLICATION

This Patent Application claims priority to U.S. Provisional Pat. Application No. 63/301,901, filed on Jan. 21, 2022, entitled “MULTI-DOMAIN NETWORK DATA FLOW MODELING,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for multi-domain network data flow modeling.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method performed by a network entity. The method may include generating a data flow model for a domain associated with the network entity, the domain being part of a multi-domain network. The method may include obtaining a set of measured flow rates and a set of expected flow rates that are calculated based at least in part on the data flow model. The method may include selectively updating the data flow model based at least in part on an accuracy of the data flow model, with the accuracy determined based at least in part on the set of measured flow rates and the set of expected flow rates.

Some aspects described herein relate to a network entity for wireless communication. The network entity may include a memory and one or more processors coupled to the memory. The one or more processors may be configured to generate a data flow model for a domain associated with the network entity, the domain being part of a multi-domain network. The one or more processors may be configured to obtain a set of measured flow rates and a set of expected flow rates that are calculated based at least in part on the data flow model. The one or more processors may be configured to selectively update the data flow model based at least in part on an accuracy of the data flow model, with the accuracy determined based at least in part on the set of measured flow rates and the set of expected flow rates.

Some aspects described herein relate to a non-transitory computer-readable medium that stores a set of instructions for wireless communication by a network entity. The set of instructions, when executed by one or more processors of the network entity, may cause the network entity to generate a data flow model for a domain associated with the network entity, the domain being part of a multi-domain network. The set of instructions, when executed by one or more processors of the network entity, may cause the network entity to obtain a set of measured flow rates and a set of expected flow rates that are calculated based at least in part on the data flow model. The set of instructions, when executed by one or more processors of the network entity, may cause the network entity to selectively update the data flow model based at least in part on an accuracy of the data flow model, with the accuracy determined based at least in part on the set of measured flow rates and the set of expected flow rates.

Some aspects described herein relate to an apparatus for wireless communication. The apparatus may include means for generating a data flow model for a domain associated with the network entity, the domain being part of a multi-domain network. The apparatus may include means for obtaining a set of measured flow rates and a set of expected flow rates that are calculated based at least in part on the data flow model. The apparatus may include means for selectively updating the data flow model based at least in part on an accuracy of the data flow model, with the accuracy determined based at least in part on the set of measured flow rates and the set of expected flow rates.

Aspects generally include a method, apparatus, system, computer program product, non-transitory computer-readable medium, user equipment, base station, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of network modeling, in accordance with the present disclosure.

FIGS. 4 and 5 are diagrams illustrating examples associated with multi-domain network data flow modeling, in accordance with the present disclosure.

FIG. 6 is a diagram illustrating an example process associated with multi-domain network data flow modeling, in accordance with the present disclosure.

FIG. 7 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

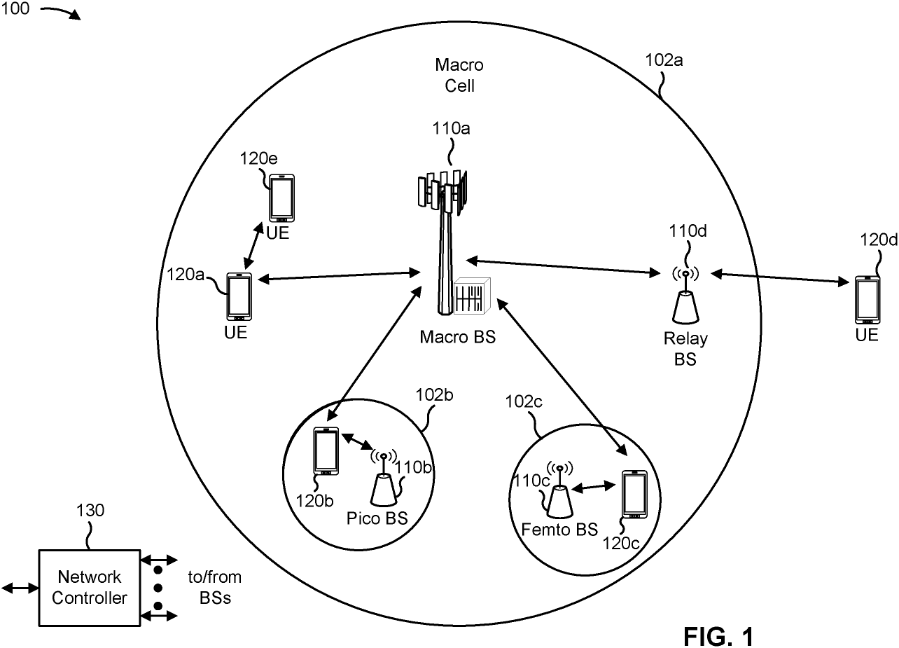

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz - 7.125 GHz) and FR2 (24.25 GHz - 52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz - 300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz - 24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz - 71 GHz), FR4 (52.6 GHz - 114.25 GHz), and FR5 (114.25 GHz - 300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

As indicated above, FIG. 1 is provided as an example. Other examples may differ from what is described with regard to FIG. 1.

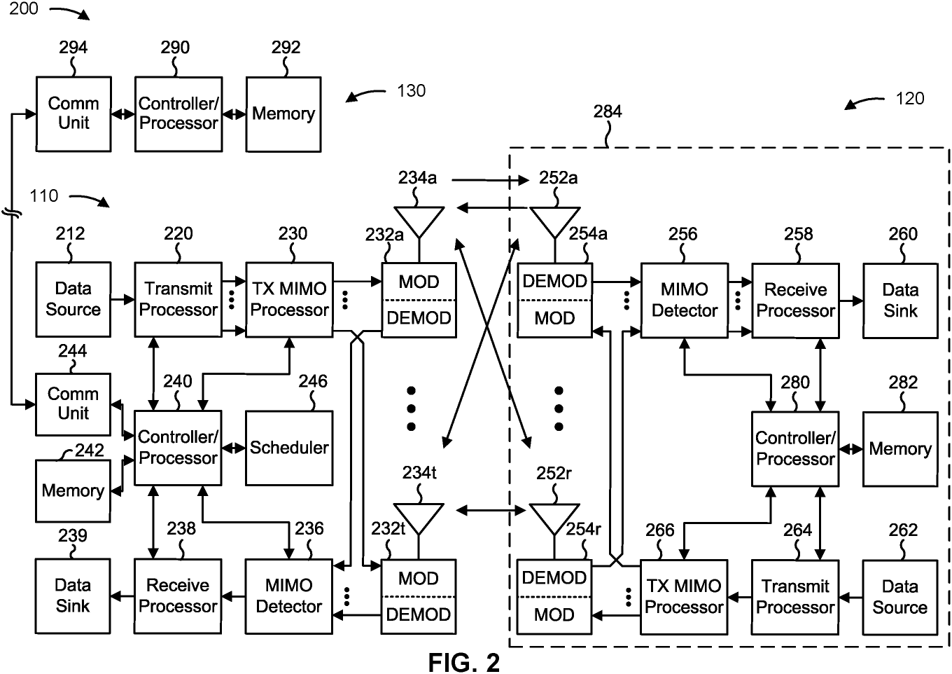

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T ≥ 1). The UE 120 may be equipped with a set of antennas 252a through 252r, such as R antennas (R ≥ 1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

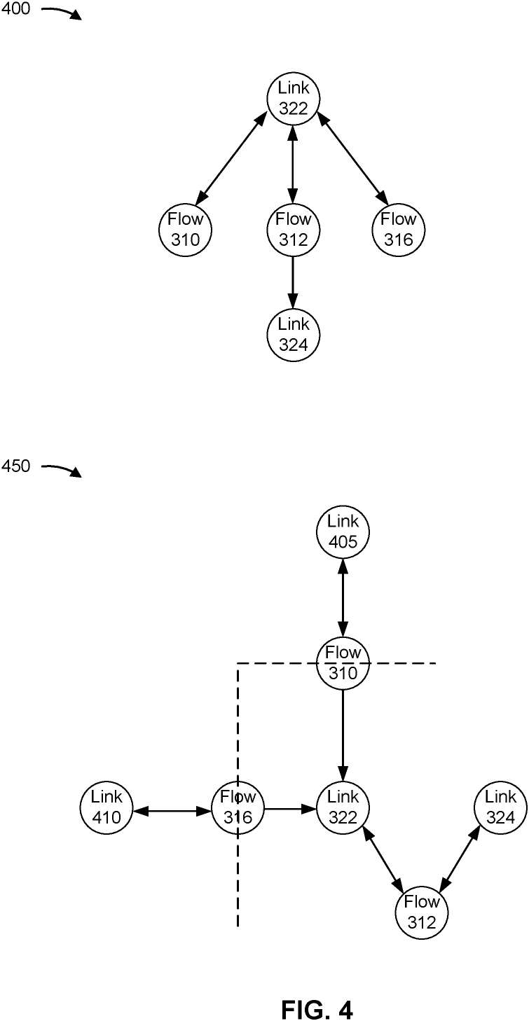

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-7).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-7).

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

In some communication environments, data flows traverse multiple domains (e.g., network domains), with each domain administered by a network entity (e.g., an operator) that is responsible for maintaining a local domain associated with the network entity (e.g., its own domain) and ensuring interoperability with others of the multiple domains traversed by a data flow. The data flows may, for example, carry data (e.g., a data stream) between multiple UEs, between a UE and an application server, between multiple base stations, between backhaul nodes, and/or between base stations. The data flows provide a pathway for the data between end nodes associated with the data (e.g., a receiving device and a transmitting device and/or between a generating device and a receiving device, among other examples). An example of a multi-domain network (e.g., a network including multiple domains) is the Internet itself, designed as a network of interconnected networks.

In multi-domain networking environments, each operator may have visibility of only a local network (e.g., devices and flows within a domain and/or a network associated with the operator). In particular, operators may determine a topology of the local network, a capacity of each link of the local network, classes of quality of service (QoS) available, and data flows currently active in their network, but usually have no knowledge about the structure and state of any other network in the multi-domain environment. For instance, a data flow may need to cross two network domains including a first domain associated with a first operator and a second domain operated by a second operator. The first operator may not have visibility into the second domain (e.g., a network within the second domain), and the second operator may not have visibility into the first domain (e.g., a network within the first domain). Therefore, each operator and/or domain may be unable to independently satisfy an end-to-end QoS as required by the data flow that extends across the first domain and the second domain.

To manage data flows within a domain (e.g., a network of devices within the domain), a network entity of the operator may generate and/or use a data flow model. The data flow model (e.g., a bottleneck structure and/or a flow gradient graph) may include a computational graph that characterizes a state of the domain, which may allow computation of network derivatives. These derivatives may be used to optimize the domain for traffic engineering, routing, flow scheduling, capacity planning, resilience analysis, and/or network design, among other examples. To generate the data flow model for the domain (e.g., the network of devices within the domain), the network entity may require information associated with a set of links traversed by flows of the domain and a capacity of the set of links. In a multi-domain networking environment, however, such information is only known partially. For instance, in the example above, a first network entity associated with the first operator associated with a first network entity may only have access to a first set of links, that reside within the first domain, traversed by a flow, but the first network entity may be unaware of a second set of links traversed by the flow that reside in the second domain. In some multi-domain networking environments, information of the second set of links may be considered confidential for security, privacy, and/or competitiveness reasons. Without the information of the second links, the first network entity may be unable to accurately generate the data flow model. Without the data flow model, the first network entity may be unable to compute network derivatives that would otherwise be used to conserve network resources (e.g., based at least in part on improved routing of data) and/or improve performance of the data flow.

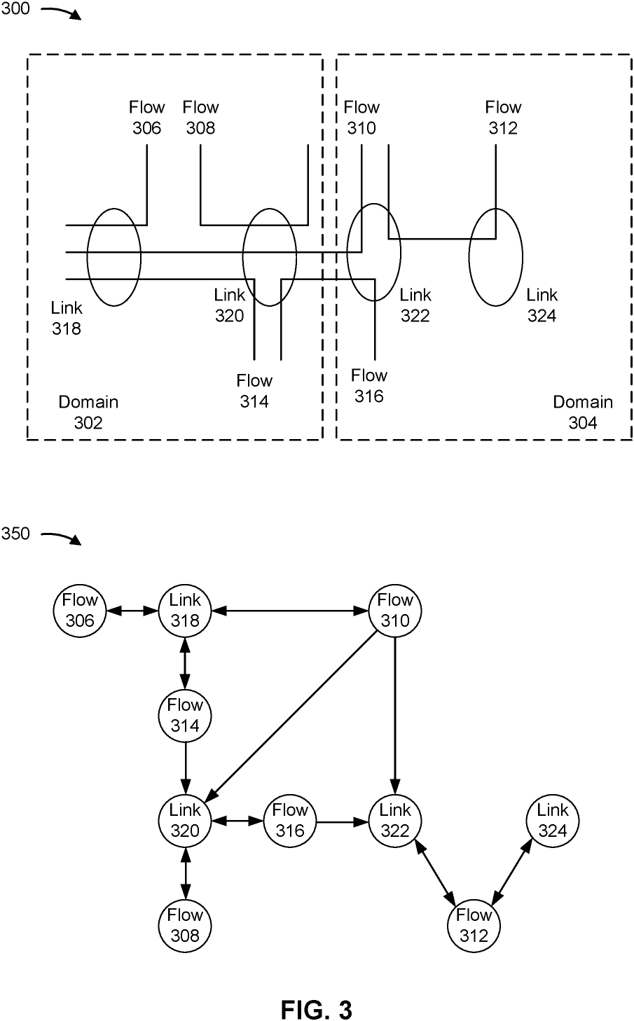

FIG. 3 is a diagram illustrating examples 300 and 350 of network modeling, in accordance with the present disclosure. As shown in example 300, a multi-domain network includes a first domain 302 and a second domain 304. The first domain 302 may be operated by a first network entity and/or a first operator and the second domain 304 may be operated by a second entity and/or a second operator.

The multi-domain network includes multiple data flows (“flows”) and multiple links that connect two or more of the multiple data flows. Some of the data flows terminate on both ends within a single domain, and some of the data flows terminate within the first domain 302 at a first end and terminate within the second domain 304 at a second end. The multiple data flows may include one or more connected networking devices (e.g., networking nodes) and/or multiple network connections between the one or more network devices. The multiple links may include one or more networking nodes that include an ingress into, and/or egress out from, one or more of the multiple data flows such that data may move from one data flow to another data flow.

The multiple data flows include flow 306 that terminates within the first domain 302 at a first end and enters another domain that is not shown. Flow 308 terminates on both ends within the first domain 302. Flow 310 terminates within the second domain 304 and traverses the first domain 302 to terminate in another domain that is not shown. Flow 312 terminates on both ends within the second domain 304. Flow 314 terminates within the first domain 302 at a first end and enters another domain that is not shown. Flow 316 terminates within the first domain 302 at a first end and terminates within the second domain 304 at a second end.

The multiple links include link 318 that connects flow 306, flow 310, and flow 314 within the first domain 302. Link 320 connects flow 308, flow 310, flow 314, and flow 316 within the first domain 302. Link 322 connects flow 310, flow 312, and flow 316 within the second domain 304. Link 324 provides a connection to flow 312 that may be used to adjust a configuration of the domain 304, or that may be used to connect flow 312 to another flow not shown in FIG. 3.

Each of the multiple links may be associated with a capacity. For example, link 318 may have a capacity of 25 units of data per second (e.g., gigabits per second), link 320 may have a capacity of 50 units of data per second, link 322 may have a capacity of 100 units of data per second, and link 324 may have a capacity of 75 units of data per second.

Each of the multiple data flows may be associated with an actual data flow rate based at least in part on the multiple data flows sharing capacities of the multiple links. For example, link 318 may divide the capacity of 25 units of data per second between communications with flow 306, flow 310, and flow 314. The data flow rate of flow 306 may be 8.3 units of data per second, the data flow rate of flow 308 may be 16.6 units of data per second, the data flow rate of flow 310 may be 8.3 units of data per second, the data flow rate of flow 312 may be 75 units of data per second, the data flow rate of flow 314 may be 8.3 units of data per second, and the data flow rate of flow 316 may be 16.6 units of data per second. Based at least in part on the data flow rates, one or more of the links may be bottleneck links (e.g., a link that reduces the data flow rates that could otherwise be higher if the link had higher capacity). Bottleneck links of a data flow may include a set of link vertices in a data flow structure such that there exists a directed edge from any of these links to the data flow.

Example 350 shows a data flow model that indicates connections that are bottleneck links (indicated with a line having arrows at both ends) and non-bottleneck links (indicated with a line having an arrow at only one end). To accurately generate the data flow model that includes both of the first domain 302 and the second domain 304, a network entity may require an oracle view (e.g., having access to the capacities and observed data flow rates of links and data flows of both domains). For example, if a network entity of the first domain 302 does not have access to capacities of links within the second domain, the network entity of the first domain may incorrectly determine that a non-bottleneck link is a bottleneck link. This may cause the network entity to incorrectly model the first domain 302, to consume network resources in an attempt to optimize the first domain 302 using incorrect information, and/or to reduce performance of the first domain and the multidomain network.

As indicated above, FIG. 3 is provided as an example. Other examples may differ from what is described with regard to FIG. 3.

In some aspects described herein, a network entity associated with a domain may improve accuracy of a data flow model generated without an oracle view into neighbor domains (e.g., with only partial information for one or more flows that traverse the domain and terminate outside of the domain). In particular, the network entity may compute the data flow model (e.g., a bottleneck structure of the domain or a bottleneck substructure) using flow throughput information (e.g., real-time flow throughput information) to update and/or revise the data flow model that was generated without topology (e.g., a configuration of network devices, data flows, and/or links) and flow visibility into the neighbor domains. The network entity may measure flow throughput (e.g., flow rates) by observing flow in the domain. The network entity may check an accuracy of the data flow model based at least in part on a set of measured flow rates and a set of expected flow rates that are calculated based at least in part on the data flow model. Based at least in part on the measured flow rates and the expected flow rates differing by a threshold amount, the network entity may determine that the data flow model is inaccurate. The network entity may update the data flow model based at least in part on adding a virtual link to one or more flows that are identified as having a flow rate that differs from an expected flow rate. In this way, the data flow model may use the virtual link to account for the flow rate differing from the expected flow rate using the previous iteration of the data flow model. The network entity may then use the updated data flow model to determine whether a bottleneck link is within the domain (indicating that the network entity may be able to cure the bottleneck) or outside of the domain.

Some aspects described herein refer to data flows. In some aspects, a path may represent a set of data flows that include a shared set of links within a domain. For example, a path may include one or more data flows that share a set of links that connect an ingress to a domain to an egress from the domain, a same set of links that connect an ingress to the domain to an end node within the domain, or a same set of links that connect an egress to a source node within the domain. In some aspects, example, a bottleneck structure may be constructed and/or used based at least in part on a set of paths, with each path having information associated with one or more flows that have been collapsed (e.g., combined or reduced) into a single vertex. For example, a path model (e.g., a path gradient graph (PGG)) may include a bottleneck structure with a reduced size (e.g., relative to a bottleneck structure that models data flows individually) based at least in part on collapsing all vertices of data flows that follow a same path into a single vertex (e.g., a path vertex). Using the path model may support a compact representation of a bottleneck structure graph (e.g., with reduced computational complexity and memory storage) without reducing accuracy.

FIG. 4 is a diagram illustrating examples 400 and 450 associated with multi-domain network path modeling (e.g., data flow modeling), in accordance with the present disclosure. The diagram illustrates flows and links within the second domain 304 of the multidomain network shown in FIG. 3. The diagram may be a bottleneck substructure that includes data flows found within the second domain 304 and links found in the second domain 304, and edges in a data flow structure of multiple domains of the multi-domain structure that connect the data flows and the links found within the second domain. If a data flow in the second domain is bottlenecked at a link that is not within the second domain, a network entity may add a virtual link with a share of data flow rate (e.g., equal to the expected data flow rate of the data flow) and a directed edge from the virtual link to the flow (e.g., the virtual link is a bottleneck link). The network entity may be contained within one computing device or may be distributed over multiple computing devices. The network entity may include a network controller, such as hardware that includes a software-defined network (SDN) controller.

As shown in example 400, the network entity may generate a preliminary data flow model that includes only links that are within the second domain 304 and flows that are within the second domain 304. As shown, the network entity is unaware of any links outside of the second domain, so the network entity generates the preliminary data flow model having bottleneck links for all connections of link 322.

However, as shown in FIG. 3, link 322 is not a bottleneck link for flow 310 and flow 316, but links that are outside of the second domain 304 are the bottleneck links for flow 310 and flow 316. In this way, the preliminary data flow model is inaccurate, but the network entity is unaware of the inaccuracy until checking the preliminary data flow model against measured and/or observed data flow rates of the domain.

The network entity may obtain (e.g., generate or receive from another device, among other examples) expected flow rates for flow 310, flow 312, and flow 316 based at least in part on the preliminary data flow model. Based at least in part on link 322 having, for example, a known capacity of 100 units of data per second (e.g., known because the link is within the second domain 304), the network entity may estimate that flow rates of each flow will be 33.3 units of data per second.

However, during operation, the network entity may obtain a set of measured flow rates based at least in part on measuring the data flows or receiving an indication of measurements of the data flows. The set of measured flow rates may include a flow rate of 16.6 data units per second for flow 310, a flow rate of 75 data units per second for flow 312, and a flow rate of 8.3 data units per second for flow 316. Based at least in part on the set of measured flow rates differing from the expected flow rates (e.g., by a threshold amount), the network entity may determine that the data flow model is inaccurate.

As shown in example 450, the network entity may generate an updated data flow model that is based at least in part on adding a virtual link 405 and a virtual link 410 to the data flow model. The network entity may add virtual links connected to flow 310 and flow 316 based at least in part on the associated measured flow rates being less than the associated expected flow rates. The network entity may not add a virtual link connected to flow 312 based at least in part on flow 312 being connected to link 324 that is within the second domain 304 and/or based at least in part on the measured flow rate to link 322 being equal to or greater than the expected flow rate to link 322.

Based at least in part on the virtual links 405 and 410 being added to the data flow model, the network entity may accurately model the second domain 304. For example, the network entity may accurately model link 322 as a non-bottleneck link of flow 316 and as a non-bottleneck link of flow 310. Additionally, the network entity may accurately model the links 324 and 322 as both bottleneck links of flow 312 (e.g., based at least in part on having a same amount of available capacity for flow 312). In this way, the network entity may calculate accurate network derivatives of the second domain. These derivatives may be used to optimize the domain for traffic engineering, routing, flow scheduling, capacity planning, resilience analysis, and/or network design, among other examples. In this way, the network device may conserve network resources that may otherwise have been used to attempt to optimize the second domain 304 using incorrect information, and/or may improve performance (e.g., satisfaction of QoS requirements and efficient use of network resources, among other examples) of the second domain and the multidomain network.

The following is an example procedure (e.g., an iterative procedure) to generate the data flow models shown in FIG. 4:

1. Set i = 0;
2. L_0 = L;
3. FL 0 = FL;
4. While True:
4.1. B_i = COMPUTE_BOTTLENECK_STRUCTURE(FL_i, L_i, {c l for all
in L_i});₃
4.2. If B i.r_f = r*_f for all flow f in F:
4.2.1. Break;
4.3. For all flow f in F such that B i.r_f > r*_f:
4.3.1. Add a new virtual link v to the set L_i;
4.3.2. Set c v = r *_f;
4.3.3. Add virtual link v to the set of links FL_i[f];
4.4. i = i + 1;
4.5. L_i = L_{i-l};
4.6. FL_i = FL_{i-l};
5. Return FL_i, L_i, {c l, for all 1 in L i}.

In the example procedures, B_i is an iteration of the data flow model of the multidomain network, B_i.r_f is an iteration of a theoretical rate of flow f (e.g., a rate of flow f according to the data flow model B), F is a set of flows ({f_1, ...,f_{|F|}}) found in a network domain under observation, L is a set of links ({l_1, ..., l_{|L|}}) found in the network domain under observation, FL is a data store mapping a flow with the subset of links in L that the flow traverses (a flow f can traverse one or more links not in L based at least in part on the network entity having only partial information inherent to multidomain networking environments), c_l is a capacity of a link l in L, and r*_f is an observed and/or measured steady state of transmission rate of flow f for any flow f in F.

In some aspects, a bottleneck structure may include a path model that is based at least in part on information associated with the data flow model. For example, the path model may include a PGG with a reduced size relative to the data flow model based at least in part on collapsing all vertices of data flows that follow a same path into a single vertex (e.g., a path vertex). Using the path model may support a compact representation of a bottleneck structure graph (e.g., with reduced computational complexity and memory storage) without reducing accuracy or with reducing accuracy by an amount that satisfies an accuracy threshold. For example, the bottleneck structure may include information associated with paths of the domain and/or multi-domain network, which may reduce the size of the bottleneck structure based at least in part on the domain and/or a network having hundreds of paths and millions or billions of flows. In this way, the information of the bottleneck structure may be collapsed into a reduced set of information for data flow management.

In some aspects, the following procedure may be used to generate a path model associated with the data flow model of FIG. 4:

1. i = 0; L_0 = L; PL_0 = PL;
2. While True: 2.1. B_i = COMPUTE_BOTTLENECK_STRUCTURE(L_i,
PL_i, C);
2.2. If B_i.BW(p) == PM(p) for all path p in PL_i:
2.2.1. Break;
2.3. For all path p in PL_i such that B_i.BW(p) > PM(p):
2.3.1. If PL_i[p] has no virtual link:
2.3.1.1. Add a new virtual link v to the set of links PL_i[p];
2.3.1.2. Add virtual link v to the set L_i;
2.3.2. Set C(v) = PM(p);
2.4. i = i + 1;
2.5. L_i = L_{i-1};
2.6. PL_i =PL_{i-1};
3. Return B_i;

As indicated above, FIG. 4 is provided as an example. Other examples may differ from what is described with regard to FIG. 4.

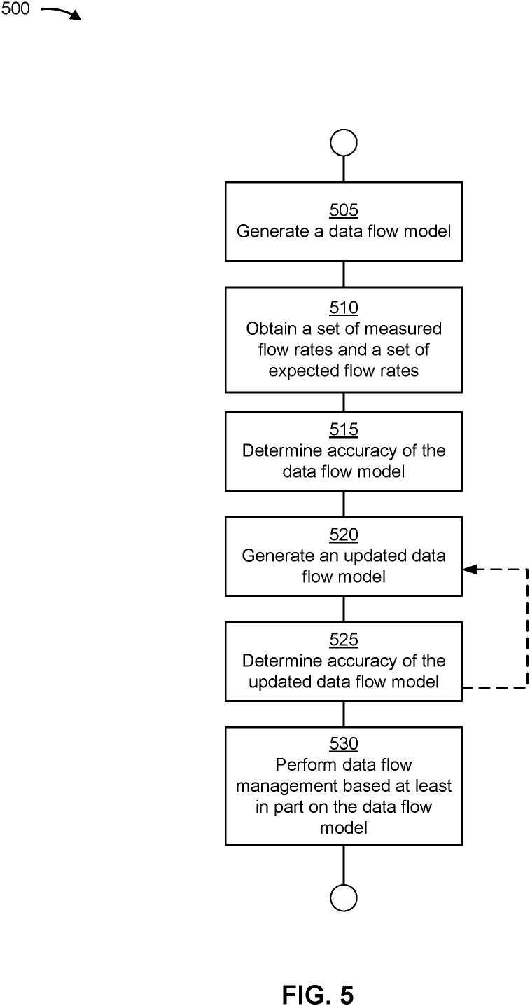

FIG. 5 is a diagram of an example process 500 associated with multi-domain network data flow modeling, in accordance with the present disclosure. As shown in FIG. 5, a network entity may generate a data flow model for a domain associated with the network entity, with the domain being associated with a multidomain network in which the network entity has limited or no visibility of a network configuration of one or more neighbor domains. In some aspects, one or more data flows of the domain may traverse a first domain associated with the network entity and a neighbor domain associated with a neighbor network entity. In some aspects, the one or more data flows may be associated with a data stream that has a QoS requirement (e.g., a communication involving UE 120 or another end node). In some aspects, the network entity may be configured to perform data flow management of the domain based at least in part on the data flow model. For example, the network entity and/or the neighbor network entity may be responsible for ensuring that bottleneck links of the one or more data flows satisfy the QoS requirement.

As shown by reference number 505, the network entity may generate a data flow model. For example, the network entity may generate the data flow model using only links and data flows found within the domain, as described in connection with FIG. 4. In some aspects, the data flow model indicates one or more of bottleneck links or non-bottleneck links of one or more data flows within the domain. In some aspects, the data flow model may be based at least in part on information associated with a set of data flow and/or a set of paths (e.g., with information combined from one or more data flows that share a path and/or a set of links). In some aspects, the data flow model may include a PGG model.

As shown by reference number 510, the network entity may obtain a set of measured flow rates and a set of expected flow rates. In some aspects, the network entity may obtain the set of measured flow rates from a measurement device and/or a network node associated with the one or more data flows (e.g., network nodes). In some aspects, the set of expected flow rates are calculated based at least in part on the data flow model.

In some aspects, the set of expected flow rates is based at least in part on calculated capacities of links traversed by flows within the domain. In some aspects, the set of measured flow rates is based at least in part on observed transmission rates of flows through links.

As shown by reference number 515, the network entity may determine an accuracy of the data flow model. The accuracy of the data flow model may be determined based at least in part on the set of measured flow rates and the set of expected flow rates. In some aspects, the data flow model may be inaccurate based at least in part on one or more data flows of the domain having a bottleneck link outside of the domain. For example, if the one or more data flows of the domain have a bottleneck link outside of the domain, a first iteration of the data flow model may inaccurately indicate that a link inside of the domain is a bottleneck link.

As shown by reference number 520, the network entity may generate an updated data flow model. In some aspects, the network entity may selectively update the data flow model based at least in part on an accuracy of the data flow model. For example, based at least in part on a determination of inaccuracy, the network entity may generate the updated data flow model. Based at least in part on a determination of accuracy, an update may be unnecessary and the data flow model may be finalized and ready to use for data flow management.

In some aspects, the network entity may generate the updated data flow model based at least in part on identifying a data flow for which an expected flow rate is greater than a measured flow rate. The network entity may add a virtual link to a set of links modeled via the data flow model. The virtual link may be associated with the data flow and the measured flow rate. In this way, a bottleneck (e.g., where the expected flow rate is greater that the measured flow rate) may be attributed to the virtual link that represents a link outside of the domain.

As shown by reference number 525, the network entity may determine accuracy of the updated data flow model. Based at least in part on the network entity determining that the updated data flow model is inaccurate, the network entity may generate another updated data flow model in an iterative process. For example, the network entity may generate an updated data flow model based at least in part on iteratively updating the data flow model until a difference between the set of measured flow rates and a set of updated expected flow rates satisfies an accuracy threshold.

As shown by reference number 530, the network entity may perform data flow management based at least in part on the data flow model. In some aspects, data flow management may be based at least in part on identifying one or more bottleneck links of the domain, one or more alternative flows for propagating data, and/or one or more links that are available to link one or more flows, among other examples. In some aspects, data flow management may include traffic engineering, routing, flow control, flow scheduling, capacity planning, network change planning, robustness analysis, service level agreement management, resilience analysis, network modeling, flow performance prediction, and/or resource allocation, among other examples.

Based at least in part on the network entity updating the data flow model based at least in part on measured flow rates and expected flow rates, the data flow model may use the virtual link to account for the flow rate differing from the expected flow rate using a previous iteration of the data flow model. The network entity may then use the updated data flow model to determine whether a bottleneck link is within the domain (indicating that the network entity may be able to cure the bottleneck) or outside of the domain.

In this way, the network device may conserve network resources that may otherwise have been used to attempt to optimize the domain using incorrect information, and/or may improve performance (e.g., satisfaction of QoS requirements and efficient use of network resources, among other examples) of the domain and the multidomain network.

As indicated above, FIG. 5 is provided as an example. Other examples may differ from what is described with regard to FIG. 5. In some aspects, process 500 may be modified to support path modeling as a type of data flow modeling (e.g., a type of bottleneck structure, such as a PGG). For example, a first modified process may include generating a path model (e.g., based at least in part on combining information associated with data flows based at least in part on having shared paths), obtaining a set of measured flow rates and a set of expected flow rates, and determining an accuracy of the path flow model. The first modified process may include iterations of generating an updated path model and determining an accuracy of the updated path model (e.g., until the updated path model is accurate based at least in part on measured flow rates and expected flow rates). The first modified process may also include performing data flow management based at least in part on the path flow model.

In a second modified process, an additional operation may be performed between operations of the process 500 to combine information from a set of data flows into a set of paths (with the set of paths having fewer members than the set of data flows). For example, the second modified process may include combining data flows into paths to generate a path model in place of generating a data flow model shown by reference number 505. The following operations may be performed on the path model rather than on the data flow model. In some aspects, the second modified process may include reducing information of the updated data flow models to be associated with paths rather than data flows to reduce a data set of the updated data flow models.

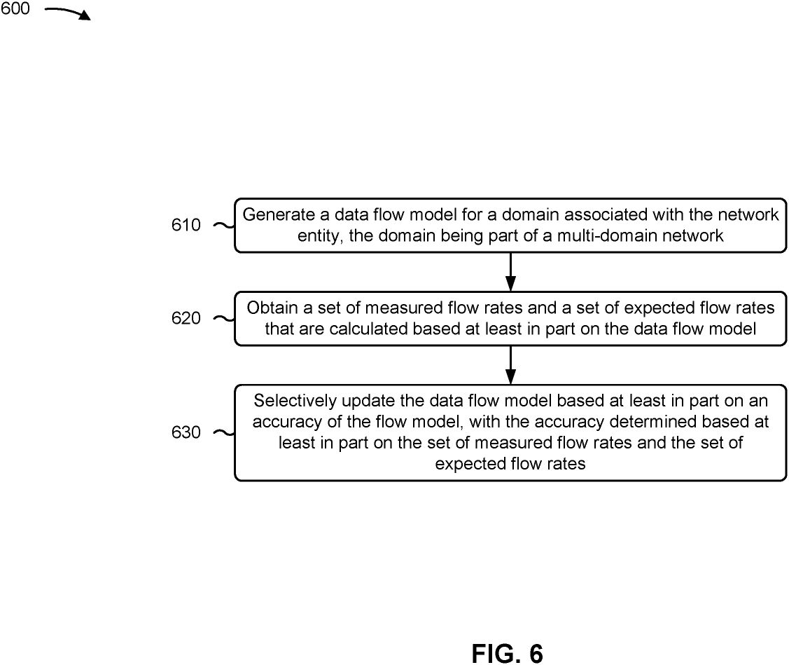

FIG. 6 is a diagram illustrating an example process 600 performed, for example, by a network entity, in accordance with the present disclosure. Example process 600 is an example where the network entity (e.g., device 700) performs operations associated with multi-domain network data flow modeling. As described herein, a data flow model described in connection with process 600 may include information that is based at least in part on paths (e.g., rather than data flows or in addition to data flows).

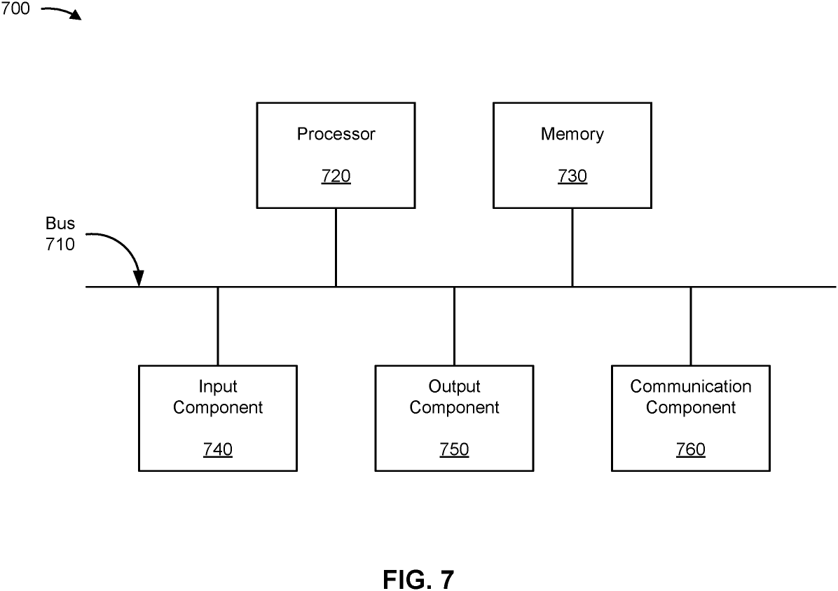

As shown in FIG. 6, in some aspects, process 600 may include generating a data flow model for a domain associated with the network entity, the domain being part of a multi-domain network (block 610). For example, the network entity (e.g., using processor 720 and/or memory 730, depicted in FIG. 7) may generate a data flow model for a domain associated with the network entity, the domain being part of a multi-domain network, as described above.

As further shown in FIG. 6, in some aspects, process 600 may include obtaining a set of measured flow rates and a set of expected flow rates that are calculated based at least in part on the data flow model (block 620). For example, the network entity (e.g., using processor 720, memory 730, and/or communication component 760, depicted in FIG. 7) may obtain a set of measured flow rates and a set of expected flow rates that are calculated based at least in part on the data flow model, as described above.

As further shown in FIG. 6, in some aspects, process 600 may include selectively updating the data flow model based at least in part on an accuracy of the data flow model, with the accuracy determined based at least in part on the set of measured flow rates and the set of expected flow rates (block 630). For example, the network entity (e.g., using processor 720 and/or memory 730, depicted in FIG. 7) may selectively update the data flow model based at least in part on an accuracy of the data flow model, with the accuracy determined based at least in part on the set of measured flow rates and the set of expected flow rates, as described above.

Process 600 may include additional aspects, such as any single aspect or any combination of aspects described below and/or in connection with one or more other processes described elsewhere herein.

In a first aspect, process 600 includes performing data flow management based at least in part on the data flow model.

In a second aspect, alone or in combination with the first aspect, performing data flow management comprises performing one or more of traffic engineering, routing, flowing control, flowing scheduling, capacity planning, network change planning, robustness analysis, service level agreement management, resilience analysis, network modeling, flowing performance prediction, or resource allocation.

In a third aspect, alone or in combination with one or more of the first and second aspects, process 600 includes generating an updated data flow model based at least in part on iteratively updating the data flow model.

In a fourth aspect, alone or in combination with one or more of the first through third aspects, iteratively updating the data flow model comprises iteratively updating the data flow model until a difference between the set of measured flow rates and a set of updated expected flow rates satisfies an accuracy threshold.

In a fifth aspect, alone or in combination with one or more of the first through fourth aspects, updating the data flow model is based at least in part on one or more data flows or paths of the domain having a bottleneck link outside of the domain.

In a sixth aspect, alone or in combination with one or more of the first through fifth aspects, the data flow model indicates one or more of bottleneck links or non-bottleneck links of one or more data flows or paths within the domain.

In a seventh aspect, alone or in combination with one or more of the first through sixth aspects, the set of expected flow rates is based at least in part on calculated capacities of links traversed by data flows or paths within the domain, and the set of measured flow rates is based at least in part on an observed transmission rate of data flow through the links.

In an eighth aspect, alone or in combination with one or more of the first through seventh aspects, selectively updating the data flow model comprises identifying a data flow or a path for which an expected flow rate is greater than a measured flow rate, and adding a virtual link to a set of links modeled via the data flow model, wherein the virtual link is associated with the data flow or the path and the measured flow rate.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram of example components of a device 700, which may correspond to a network entity described herein. In some implementations, the network entity includes one or more devices 700 and/or one or more components of device 700. As shown in FIG. 7, device 700 may include a bus 710, a processor 720, a memory 730, an input component 740, an output component 750, and a communication component 760.

Bus 710 includes one or more components that enable wired and/or wireless communication among the components of device 700. Bus 710 may couple together two or more components of FIG. 7, such as via operative coupling, communicative coupling, electronic coupling, and/or electric coupling. Processor 720 includes a central processing unit, a graphics processing unit, a microprocessor, a controller, a microcontroller, a digital signal processor, a field-programmable gate array, an application-specific integrated circuit, and/or another type of processing component. Processor 720 is implemented in hardware, firmware, or a combination of hardware and software. In some implementations, processor 720 includes one or more processors capable of being programmed to perform one or more operations or processes described elsewhere herein.

Memory 730 includes volatile and/or nonvolatile memory. For example, memory 730 may include random access memory (RAM), read only memory (ROM), a hard disk drive, and/or another type of memory (e.g., a flash memory, a magnetic memory, and/or an optical memory). Memory 730 may include internal memory (e.g., RAM, ROM, or a hard disk drive) and/or removable memory (e.g., removable via a universal serial bus connection). Memory 730 may be a non-transitory computer-readable medium. Memory 730 stores information, instructions, and/or software (e.g., one or more software applications) related to the operation of device 700. In some implementations, memory 730 includes one or more memories that are coupled to one or more processors (e.g., processor 720), such as via bus 710.

Input component 740 enables device 700 to receive input, such as user input and/or sensed input. For example, input component 740 may include a touch screen, a keyboard, a keypad, a mouse, a button, a microphone, a switch, a sensor, a global positioning system sensor, an accelerometer, a gyroscope, and/or an actuator. Output component 750 enables device 700 to provide output, such as via a display, a speaker, and/or a light-emitting diode. Communication component 760 enables device 700 to communicate with other devices via a wired connection and/or a wireless connection. For example, communication component 760 may include a receiver, a transmitter, a transceiver, a modem, a network interface card, and/or an antenna.

Device 700 may perform one or more operations or processes described herein. For example, a non-transitory computer-readable medium (e.g., memory 730) may store a set of instructions (e.g., one or more instructions or code) for execution by processor 720. Processor 720 may execute the set of instructions to perform one or more operations or processes described herein. In some implementations, execution of the set of instructions, by one or more processors 720, causes the one or more processors 720 and/or the device 700 to perform one or more operations or processes described herein. In some implementations, hardwired circuitry is used instead of or in combination with the instructions to perform one or more operations or processes described herein. Additionally, or alternatively, processor 720 may be configured to perform one or more operations or processes described herein. Thus, implementations described herein are not limited to any specific combination of hardware circuitry and software.

The number and arrangement of components shown in FIG. 7 are provided as an example. Device 700 may include additional components, fewer components, different components, or differently arranged components than those shown in FIG. 7. Additionally, or alternatively, a set of components (e.g., one or more components) of device 700 may perform one or more functions described as being performed by another set of components of device 700.

The following provides an overview of some Aspects of the present disclosure:

Aspect 1: A method performed by a network entity, comprising: generating a data flow model for a domain associated with the network entity, the domain being part of a multi-domain network; obtaining a set of measured flow rates and a set of expected flow rates that are calculated based at least in part on the data flow model; and selectively updating the data flow model based at least in part on an accuracy of the data flow model, with the accuracy determined based at least in part on the set of measured flow rates and the set of expected flow rates.

Aspect 2: The method of Aspect 1, further comprising: performing data flow management based at least in part on the data flow model.

Aspect 3: The method of Aspect 2, wherein performing data flow management comprises performing one or more of: traffic engineering, routing, flow control, flow scheduling, capacity planning, network change planning, robustness analysis, service level agreement management, resilience analysis, network modeling, flow performance prediction, or resource allocation.

Aspect 4: The method of any of Aspects 1-3, further comprising: generating an updated data flow model based at least in part on iteratively updating the data flow model.

Aspect 5: The method of Aspect 4, wherein iteratively updating the data flow model comprises: iteratively updating the data flow model until a difference between the set of measured flow rates and a set of updated expected flow rates satisfies an accuracy threshold.

Aspect 6: The method of any of Aspects 1-5, wherein updating the data flow model is based at least in part on one or more data flows or paths of the domain having a bottleneck link outside of the domain.

Aspect 7: The method of any of Aspects 1-6, wherein the data flow model indicates one or more of bottleneck links or non-bottleneck links of one or more data flows or paths within the domain.

Aspect 8: The method of any of Aspects 1-7, wherein the set of expected flow rates is based at least in part on calculated capacities of links traversed by data flows or paths within the domain, and wherein the set of measured flow rates is based at least in part on an observed transmission rate of data flow through the links.

Aspect 9: The method of any of Aspects 1-8, wherein selectively updating the data flow model comprises: identifying a data flow or a path for which an expected flow rate is greater than a measured flow rate; and adding a virtual link to a set of links modeled via the data flow model, wherein the virtual link is associated with the data flow or the path and the measured flow rate.

Aspect 10: An apparatus for wireless communication at a device, comprising a processor; memory coupled with the processor; and instructions stored in the memory and executable by the processor to cause the apparatus to perform the method of one or more of Aspects 1-9.

Aspect 11: A device for wireless communication, comprising a memory and one or more processors coupled to the memory, the one or more processors configured to perform the method of one or more of Aspects 1-9.

Aspect 12: An apparatus for wireless communication, comprising at least one means for performing the method of one or more of Aspects 1-9.

Aspect 13: A non-transitory computer-readable medium storing code for wireless communication, the code comprising instructions executable by a processor to perform the method of one or more of Aspects 1-9.

Aspect 14: A non-transitory computer-readable medium storing a set of instructions for wireless communication, the set of instructions comprising one or more instructions that, when executed by one or more processors of a device, cause the device to perform the method of one or more of Aspects 1-9.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a + b, a + c, b + c, and a + b + c, as well as any combination with multiples of the same element (e.g., a + a, a + a + a, a + a + b, a + a + c, a + b+b, a + c + c, b + b, b + b + b, b + b + c, c + c, and c + c + c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method performed by a network entity, comprising:
generating a data flow model for a domain associated with the network entity, the domain being part of a multi-domain network;
obtaining a set of measured flow rates and a set of expected flow rates that are calculated based at least in part on the data flow model; and
selectively updating the data flow model based at least in part on an accuracy of the data flow model, with the accuracy determined based at least in part on the set of measured flow rates and the set of expected flow rates.

2. The method of claim 1, further comprising:
performing data flow management based at least in part on the data flow model.

3. The method of claim 2, wherein performing data flow management comprises performing one or more of:
traffic engineering,
routing,
flow control,
flow scheduling,
capacity planning,
network change planning,
robustness analysis,
service level agreement management,
resilience analysis,
network modeling,
flow performance prediction, or
resource allocation.

4. The method of claim 1, further comprising:
generating an updated data flow model based at least in part on iteratively updating the data flow model.

5. The method of claim 4, wherein iteratively updating the data flow model comprises:
iteratively updating the data flow model until a difference between the set of measured flow rates and a set of updated expected flow rates satisfies an accuracy threshold.

6. The method of claim 1, wherein updating the data flow model is based at least in part on one or more data flows or paths of the domain having a bottleneck link outside of the domain.

7. The method of claim 1, wherein the data flow model indicates one or more of bottleneck links or non-bottleneck links of one or more data flows or paths within the domain.

8. The method of claim 1, wherein the set of expected flow rates is based at least in part on calculated capacities of links traversed by data flows or paths within the domain, and
wherein the set of measured flow rates is based at least in part on an observed transmission rate of data flow through the links.

9. The method of claim 1, wherein selectively updating the data flow model comprises:
identifying a data flow or a path for which an expected flow rate is greater than a measured flow rate; and
adding a virtual link to a set of links modeled via the data flow model, wherein the virtual link is associated with the data flow or the path and the measured flow rate.

10. A network entity for wireless communication, comprising:
a memory; and
one or more processors, coupled to the memory, configured to:
generate a data flow model for a domain associated with the network entity, the domain being part of a multi-domain network;
obtain a set of measured flow rates and a set of expected flow rates that are calculated based at least in part on the data flow model; and
selectively update the data flow model based at least in part on an accuracy of the data flow model, with the accuracy determined based at least in part on the set of measured flow rates and the set of expected flow rates.

11. The network entity of claim 10, wherein the one or more processors are further configured to:
perform data flow management based at least in part on the data flow model.

12. The network entity of claim 11, wherein the one or more processors, to perform data flow management, are configured to perform one or more of:
traffic engineering,
routing,
flow control,
flow scheduling,
capacity planning,
network change planning,
robustness analysis,
service level agreement management,
resilience analysis,
network modeling,
flow performance prediction, or
resource allocation.

13. The network entity of claim 10, wherein the one or more processors are further configured to:
generate an updated data flow model based at least in part on iteratively updating the data flow model.

14. The network entity of claim 13, wherein the one or more processors, to iteratively update the data flow model, are configured to:
iteratively update the data flow model until a difference between the set of measured flow rates and a set of updated expected flow rates satisfies an accuracy threshold.

15. The network entity of claim 10, wherein updating the data flow model is based at least in part on one or more data flows or paths of the domain having a bottleneck link outside of the domain.

16. The network entity of claim 10, wherein the data flow model indicates one or more of bottleneck links or non-bottleneck links of one or more data flows or paths within the domain.

17. The network entity of claim 10, wherein the set of expected flow rates is based at least in part on calculated capacities of links traversed by data flows or paths within the domain, and
wherein the set of measured flow rates is based at least in part on an observed transmission rate of data flow through the links.

18. The network entity of claim 10, wherein the one or more processors, to selectively update the data flow model, are configured to:
identify a data flow or a path for which an expected flow rate is greater than a measured flow rate; and
add a virtual link to a set of links modeled via the data flow model, wherein the virtual link is associated with the data flow or the path and the measured flow rate.

19. A non-transitory computer-readable medium storing a set of instructions for wireless communication, the set of instructions comprising:
one or more instructions that, when executed by one or more processors of a network entity, cause the network entity to:
generate a data flow model for a domain associated with the network entity, the domain being part of a multi-domain network;
obtain a set of measured flow rates and a set of expected flow rates that are calculated based at least in part on the data flow model; and
selectively update the data flow model based at least in part on an accuracy of the data flow model, with the accuracy determined based at least in part on the set of measured flow rates and the set of expected flow rates.

20. The non-transitory computer-readable medium of claim 19, wherein the one or more instructions further cause the network entity to:
generate an updated data flow model based at least in part on iteratively updating the data flow model.

21. The non-transitory computer-readable medium of claim 20, wherein the one or more instructions, that cause the network entity to iteratively update the data flow model, cause the network entity to:
iteratively update the data flow model until a difference between the set of measured flow rates and a set of updated expected flow rates satisfies an accuracy threshold.

22. The non-transitory computer-readable medium of claim 19, wherein updating the data flow model is based at least in part on one or more data flows or paths of the domain having a bottleneck link outside of the domain.

23. The non-transitory computer-readable medium of claim 19, wherein the set of expected flow rates is based at least in part on calculated capacities of links traversed by data flows or paths within the domain, and
wherein the set of measured flow rates is based at least in part on an observed transmission rate of data flow through the links.

24. The non-transitory computer-readable medium of claim 19, wherein the one or more instructions, that cause the network entity to selectively update the data flow model, cause the network entity to:
identify a data flow or a path for which an expected flow rate is greater than a measured flow rate; and
add a virtual link to a set of links modeled via the data flow model, wherein the virtual link is associated with the data flow or the path and the measured flow rate.

25. An apparatus for wireless communication, comprising:
means for generating a data flow model for a domain associated with the apparatus, the domain being part of a multi-domain network;
means for obtaining a set of measured flow rates and a set of expected flow rates that are calculated based at least in part on the data flow model; and
means for selectively updating the data flow model based at least in part on an accuracy of the data flow model, with the accuracy determined based at least in part on the set of measured flow rates and the set of expected flow rates.

26. The apparatus of claim 25, further comprising:
means for generating an updated data flow model based at least in part on iteratively updating the data flow model.

27. The apparatus of claim 26, wherein the means for iteratively updating the data flow model comprises:
means for iteratively updating the data flow model until a difference between the set of measured flow rates and a set of updated expected flow rates satisfies an accuracy threshold.

28. The apparatus of claim 25, wherein updating the data flow model is based at least in part on one or more data flows or paths of the domain having a bottleneck link outside of the domain.

29. The apparatus of claim 25, wherein the set of expected flow rates is based at least in part on calculated capacities of links traversed by data flows or paths within the domain, and
wherein the set of measured flow rates is based at least in part on an observed transmission rate of data flow through the links.

30. The apparatus of claim 25, wherein the means for selectively updating the data flow model comprises:
means for identifying a data flow or a path for which an expected flow rate is greater than a measured flow rate; and
means for adding a virtual link to a set of links modeled via the data flow model, wherein the virtual link is associated with the data flow or the path and the measured flow rate.
